(19) United States
(12) Patent Application Publication
(10) Pub. No.: US 2018/0059695 A1
(43) Pub. Date: Mar. 1, 2018

(54) ENVIRONMENTAL CONTROL SYSTEM

(71) Applicant: Rick Carignan, Derry, NH (US)

(72) Inventor: Rick Carignan, Derry, NH (US)

(21) Appl. No.: 15/252,426

(22) Filed: Aug. 31, 2016

(51) Int. Cl. G05D 27/02; F24F 11/00

(52) U.S. Cl. CPC G05D 27/02; F24F 2011/0002; F24F 11/0008

(57) ABSTRACT

An environmental control system is provided. The control system is configured to minimize formation of condensation by measuring dew points and temperatures. A system controller activates an air controller or air conditioner based on these monitored parameters such as a fan to move air between a controlled environment and evaluation environment or to recondition the air inside the control environment to maintain proper conditions within the controlled environment.

### BACKGROUND OF THE INVENTION

### Field of the Invention

The present invention relates generally to environmental controllers. More particularly the present invention relates to a system that maintains an enclosure environment at conditions sufficient to prevent condensation.

### Description of Related Art

In enclosures or enclosed environments, humidity levels coupled with temperature swings can lead to condensation. Condensation may be in the form of liquid, ice, or other materials that may be converted from gas into liquid under certain environmental conditions. This condensation may cause substantial damage, as well as problems such as mold and other microbial growth. Therefore, the need exists to maintain an enclosure or enclosed area at conditions to prevent said condensation.

### SUMMARY OF THE INVENTION

The subject matter of this application may involve, in some cases, interrelated products, alternative solutions to a particular problem, and/or a plurality of different uses of a single system or article.

In one aspect, an environmental control system is provided. The system is configured to minimize or prevent formation of condensation within the controlled environment. The system is controlled and operated by a computerized controller. A first relative humidity (RH) sensor is positioned within a control environment and is in electronic communication with the computerized controller. A first temperature sensor is also positioned within the control environment, and is in electronic communication with the computerized controller. The continued measurement of the temperature and relative humidity computes the dew point for the control environment. The system further includes a second temperature sensor that is positioned within the evaluation environment and is in electronic communication with the computerized controller. The controller is configured to receive inputs from the first humidity sensor and first and second temperature sensors. Based on these inputs, the controller may operate an air controller, such as a fan, HVAC unit, or other apparatus that is configured to move a quantity of air between the control environment and evaluation environment, and/or condition the air in a controlled environment to maintain environmental conditions to limit or prevent condensation in the controlled environment.

The Controller continually measures the dew point in a control environment and compares it against the ambient air temperature in an evaluation environment. When certain conditions are met the controller causes the activation of a motor that turns on a fan/HVAC or some other type of apparatus that can cause an exchange of air between the evaluation and the control environment thereby removing the conditions that will lead to the formation of condensation to form inside the control environment. HVAC is a dehumidification apparatus that would condition the air in the control environment and would not cause and exchange of air between environments.

### BRIEF DESCRIPTION OF THE DRAWINGS

FIG. 1 provides a schematic view of an embodiment of the present invention.

FIG. 2 provides a flow chart of operation of an embodiment of the present invention.

FIG. 3 provides a flow chart of operation of an embodiment of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

The purpose of the present invention a controller that continually monitors the atmospheric conditions in a controlled environment (i.e. inside an enclosure or enclosed area) that can lead to the formation of water or liquid condensation (i.e. either in the form of liquid water, water ice or other types of materials that can be converted from a gas into a liquid when the correct environmental conditions exist).

The control system of the present invention equalizes the atmospheric conditions between a controlled environment and an evaluation environment. In one embodiment, the controlled environment may be the interior of an area of a building and the evaluation environment may be an outside ambient air. This control is provided in a relevant range that reduces the likelihood of condensation to form on the materials contained inside the control environment, thereby removing the conditions that can lead to 1) premature delamination, warping of construction materials, and other damage; 2) frost or ice that can cause rust, cracking or splintering of materials; and 3) environmental conditions that can promote unwanted and undesirable biological contaminations such as numerous kinds of mold and bacteria.

The control system of the present invention continually measures a dew point in a control environment and compares it against an ambient air temperature in an evaluation environment. When certain conditions are met, the controller causes the activation of a motor that turns on a fan/HVAC or some other type of air controller apparatus that can cause an exchange of air between the evaluation environment and the control environment or the apparatus reconditions or recirculates the air within the control environment thereby removing the conditions that will lead to the formation of condensation to form inside the control environment.

Sensors are in communication with a computerized controller. These sensors are linked to a main controller in any manner such as by way of a hard wire (low voltage), wireless communication, and the like. The controller can be hard or wirelessly linked to an AC electrical supply or can be linked to a renewable energy electrical supply device that delivers power to an electrical motor unit for purposes of activating an electrical motor that may be attached to a fan, HVAC unit, or some other type of apparatus that exchanges air between two or more environments.

In one embodiment, the present may utilize a humidity or dew point sensor in communication (wired, wireless, and the like) with the computerized controller. The dew point sensor may be positioned within the control environment to measure a dew point of the control environment.

In a further embodiment, the present invention may utilize a temperature sensor within the control environment that is in communication with the computerized controller. A second temperature sensor may further be utilized on the evaluation environment for comparison to at least one of the control environment temperature and/or control environment dew point.

An air controller such as a fan, air conditioning unit, dehumidifier, and the like may be in communication with the computerized controller and positioned to move air between the control environment and the evaluation environment or recondition the air in the control environment to remove conditions that may lead to condensation formation within the control environment.

In one configuration, the present invention may be configured to turn the air controller on under at least one of three conditions. Assuming:

T_control is the temperature in control environment;
DP_control is the dew point in the control environment;
T_eval is the temperature in evaluation environment; and
T_max is the maximum temperature value of control environment.

The maximum temperature may be a temperature setting. In one embodiment, it may be pre-programmed to 85 F, but can be adjusted. One embodiment of adjustment may be by a single turn potentiometer with range of 65 to 120 FF (18 to 50 C). The adjusted value will be stored in the controller. In embodiments with controllers having no display, the marking of the adjusting single turn potentiometer will be silkscreen or sticky label on the box to show the adjusted temperature value.

Turn ON fan condition 1: If abs (DP_control−T_eval)>4 C, then Air Controller=ON.

In other words, the air controller is turned ON if Dew point in control environment is exceeds 4 C of evaluation environment temperature.

Turn ON fan condition 2: If T_control>T_max then Air Controller=ON

In other words, air controller is turned ON if the temperature in the control environment exceeds the maximum allowed temperature.

In one configuration, the air controller may be turned off when both of two conditions are met. Turn OFF condition: IF abs(T_control−T_eval)<=4 C;

AND T_control<T_max; THEN Air Controller=OFF.

In other words, air controller is turned OFF when the temperature difference in control environment and evaluation environment is less than 4 C, AND the temperature in the control environment drops below the max temperature setting.

In varying embodiments the parameters, such as T_max, can be pre-programmed or may be adjustable. In some embodiments, other parameters may be adjustable. In a particular embodiment, the adjustment may be limited to a professional having a specialized tool to provide adjustment access.

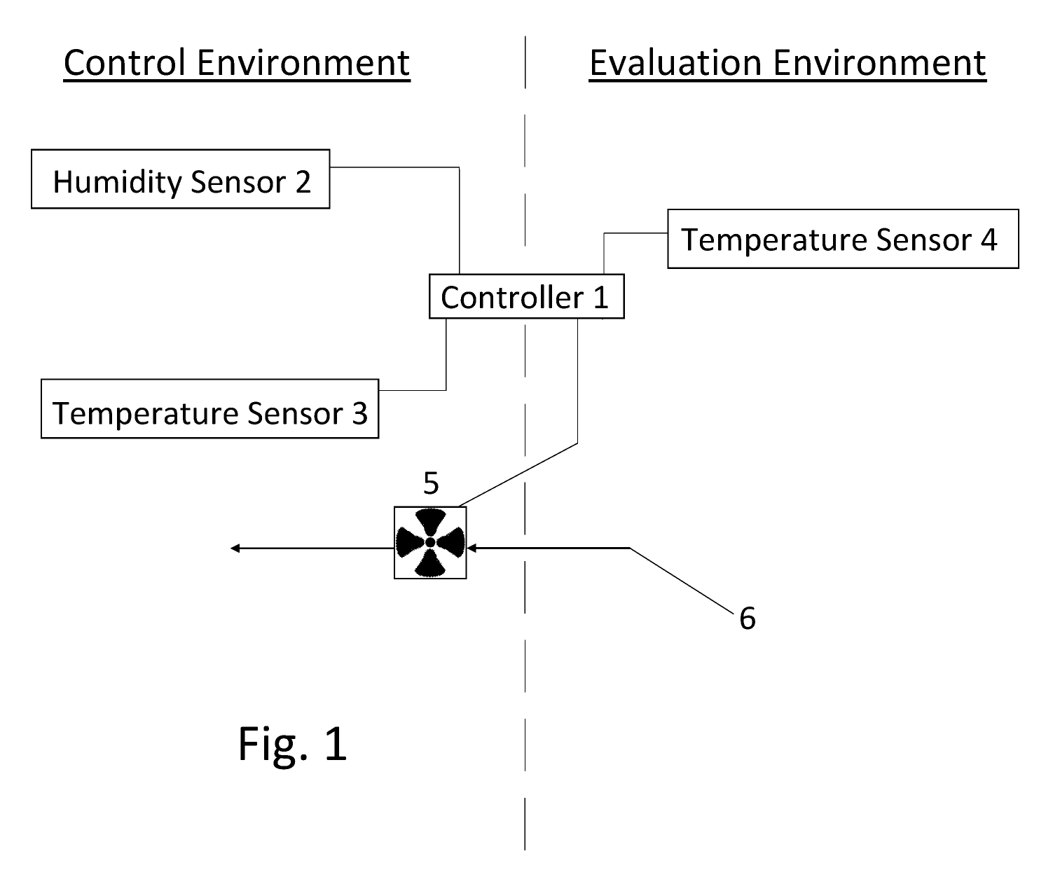

Turning now to FIG. 1, a schematic view of an embodiment of the present invention is provided. The system is separated by a vertical broken line defining the control environment (which is the environment to be controlled by the present inventive system); and the evaluation environment. A controller 1 is a computerized controller that is in communication with sensors, and a fan or similar air controlling system 5. Located within the control environment is a humidity sensor 2 which may be any sensor capable of determining a humidity within the control environment. The humidity sensor 2 is in electronic communication (wired, wireless, and the like) with controller 1 and may be configured to send a signal to controller 1 which may be converted into a humidity reading, as well as a dew point reading.

Also located within the control environment is a temperature sensor 3 which may be any sensor capable of determining a temperature within the control environment. In one embodiment, the temperature and humidity sensor 2, 3, may be combined. The temperature sensor 3 is in electronic communication (wired, wireless, and the like) with controller 1 and may be configured to send a signal to controller 1 which may be converted into a temperature reading.

A temperature sensor 4 is also positioned within the evaluation environment. These sensors are configured similarly to those in the control environment, and are also in electronic communication with controller 1 with their inputs being convertible to temperature, humidity, and/or dew point readings.

An air controller 5, shown here as a fan, is configured to blow air into or out of the control environment from/to the evaluation environment. In this view, air 6 is being blown from the evaluation environment into the control environment. The fan 5 is in communication with the controller 1 and controller 1 is configured to activate and deactivate the fan 5 depending on inputs from the humidity and temperature sensors 2, 3, 4. However, it should be understood that in varying embodiments, the air 6 may be recirculated or reconditioned depending on what type of air controller 5 is used. For example if an air conditioning air control system such as an HVAC system is the air controller 5, the air may be reconditioned instead of drawn in from outside.

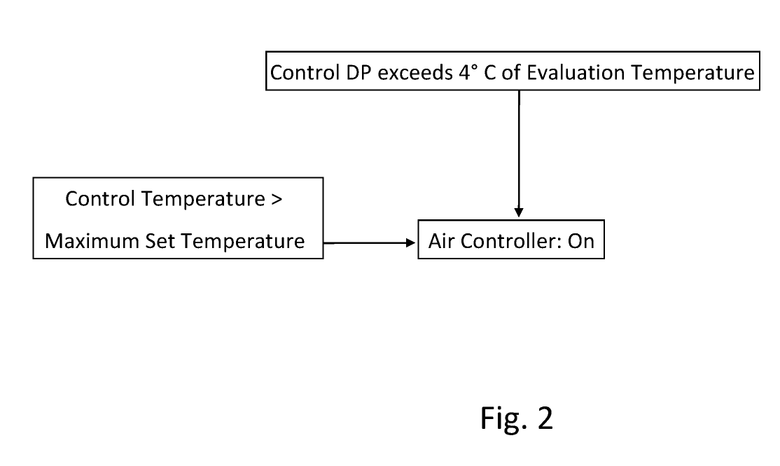

FIG. 2 shows a flow chart of an embodiment of the system having conditions when the fan 5 may be activated. As can be seen, in this embodiment, the fan 5 may be activated by controller 1 under two conditions. The first condition is if the control environment dew point is greater than four degrees Celsius of the evaluation temperature. When this is the case, the controller activates the air controller, in this embodiment, fan 5. The second condition is if the control temperature is greater than a maximum set temperature (which is a setting stored in a memory of the controller 1). When this is the case, the controller activates the air controller, in this embodiment, fan 5.

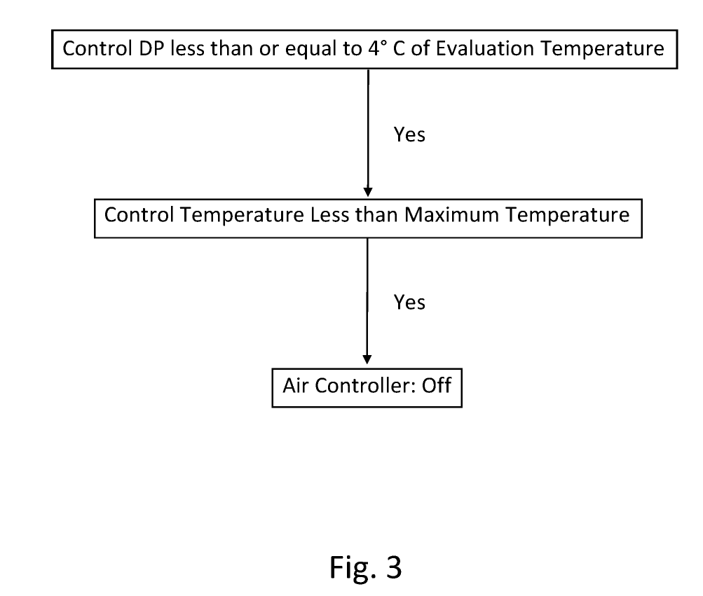

FIG. 3 provides a flow chart of an embodiment of the system having conditions when the air controller may be deactivated once activated. In this embodiment, two conditions are required to turn off the air controller. The first condition is if the control temperature is within four degrees Celsius of the evaluation temperature. If this is the case, the controller will evaluate the second condition: if the control temperature is less than a maximum set temperature. If both conditions are present, the fan is turned off. Otherwise, the fan 5 will remain active.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. An environmental control system comprising:
a computerized controller;
a first humidity sensor positioned within a control environment, the first humidity sensor in electronic communication with the computerized controller;
a first temperature sensor positioned within the control environment, the first temperature sensor in electronic communication with the computerized controller;
a second temperature sensor positioned within the evaluation environment, the second temperature sensor in electronic communication with the computerized controller;
an air controller operated by the computerized controller configured to move a quantity of air between the control environment and evaluation environment, or recondition the air in the control environment.
